(19) United States
(12) Patent Application Publication
(10) Pub. No.: US 2026/0356492 A1
(43) Pub. Date: Nov. 12, 2026

(54) SYSTEM AND METHOD FOR INTEGRATED FLIGHT TEST DISPLAY

(71) Applicant: The Boeing Company, Arlington, VA (US)

(72) Inventors: Darren G. McDonald, Federal Way, WA (US); Dulnath Daham Wijayratne, Brier, WA (US); Roger E. Friedman, Carnation, WA (US); Christopher Robert Caps, Eastsound, WA (US); Jelmer Pascal Reitsma, Frankfurt Am Main (DE); Noah Eric Aaron, Edmonds, WA (US)

(73) Assignee: The Boeing Company, Arlington, VA (US)

(21) Appl. No.: 19/205,618

(22) Filed: May 12, 2025

(51) Int. Cl. B64D 43/00

(52) U.S. Cl. CPC B64D 43/00

(57) ABSTRACT

A flight display system includes a display device associated with a flight deck of an aircraft, a pilot interface system associated with the flight deck of the aircraft, a production display graphics generator, and a flight test graphics generator. The production display graphics generator receives production flight display information associated with the aircraft, generates a production flight display based on the production flight display information, and causes the production flight display to be displayed via the display device. The flight test graphics generator receives flight test display information associated with test maneuvers for the aircraft, generates an integrated flight test display based on the flight test display information, and causes the integrated flight test display to be displayed via the display device. The display device is selectively controllable to display one of the production flight display or the integrated flight test display.

### TECHNICAL FIELD

The present disclosure generally relates to the display and presentation of flight test data within a flight display.

### BACKGROUND

Increasingly, flight test pilots are being required to fly test maneuvers in aircraft in which flight control systems for the aircraft are specifically designed to discourage such test maneuvers. The test maneuvers can include exceeding recommended load factors for the aircraft, exceeding or dropping below various airspeed limits for the aircraft, or other maneuvers. The flight control systems provide a flight display with instruments and indications that were not intended for such test maneuvers and thus may be missing relevant information that adversely affects the ability of the pilots to fly the test maneuvers safely and efficiently. The absence of relevant information can also adversely affect the quality of the test maneuvers that are flown and any associated test data captured while the test maneuvers are flown.

Although various flight deck instrumentation aids have been designed to provide test information for various test maneuvers, these aids do not provide a suitable level of augmentation and integration into the flight control system of the aircraft. That is, the flight deck instrumentation aids are often federated (e.g., requiring multiple aids that are each specific and/or limited to a particular test maneuver), distributed in different locations around the flight deck (e.g., different display screens for different aids), separate from primary flight display information, and utilize specialized flight test flight deck equipment. While providing the necessary test information, the distributed nature and separation from primary flight display information makes it difficult for pilots to act on time-sensitive data. Specifically, a pilot may be required to modify their usual instrument scan pattern, honed through extensive pilot training, to obtain the different pieces of test information as well as primary flight display information. Any modification of the instrument scan pattern can result in increased workload, loss of precision, and more human errors, reducing flight test safety and negatively affecting productivity.

### SUMMARY

The disclosed embodiments provide systems and methods that are designed, among other things, to provide an augmented flight display that incorporates additional information into a primary flight display system with which a pilot is already familiar. Using the augmented flight display system described herein, pilots can readily view both primary flight display information and flight test information within a same display interface of a flight display.

Aspects of the present disclosure are directed to a flight display system comprising: a display device associated with a flight deck of an aircraft; a pilot interface system associated with the flight deck of the aircraft; a production display graphics generator comprising a production processor and a production memory device that stores a first plurality of instructions; and a flight test graphics generator comprising a flight test processor and a flight test memory device that stores a second plurality of instructions. The first plurality of instructions, when executed by the production processor, cause the production processor to: receive production flight display information associated with the aircraft; generate a production flight display based on the production flight display information; and cause the production flight display to be displayed via the display device. The second plurality of instructions, when executed by the flight test processor, cause the flight test processor to: receive flight test display information associated with test maneuvers for the aircraft; generate an integrated flight test display based on the flight test display information; and cause the integrated flight test display to be displayed via the display device. The display device is selectively controllable to display one of the production flight display or the integrated flight test display.

Aspects of the present disclosure are directed to a flight display system comprising: a plurality of display devices associated with a flight deck of an aircraft; a pilot interface system associated with the flight deck of the aircraft; a flight test graphics generator comprising a flight test processor and a flight test memory device that stores a plurality of instructions. The plurality of instructions, when executed by the flight test processor, cause the flight test processor to: receive production flight display information associated with the aircraft; generate a production flight display based on the production flight display information; receive flight test display information associated with test maneuvers for the aircraft; generate an integrated flight test display based on the flight test display information; and selectively cause the integrated flight test display and the production flight display to be displayed via the plurality of display devices.

Aspects of the present disclosure are directed to a flight display system comprising: a plurality of display devices associated with a flight deck of an aircraft; a pilot interface system associated with the flight deck of the aircraft; a production display graphics generator comprising a production processor and a production memory device that stores a first plurality of instructions; and a flight test graphics generator comprising a flight test processor and a flight test memory device that stores a second plurality of instructions. The first plurality of instructions, when executed by the production processor, cause the production processor to: receive production flight display information associated with the aircraft; and generate a production flight display based on the production flight display information. The second plurality of instructions, when executed by the flight test processor, cause the flight test processor to: receive the production flight display from the production display graphics generator; receive flight test display information associated with test maneuvers for the aircraft; generate an integrated flight test display based on the flight test display information for display via the plurality of display devices; automatically select a first display device of the plurality of display devices and display the production flight display via the first display device; and automatically select a second display device of the plurality of display devices and display the integrated flight test display via the second display device.

These and other embodiments, and various permutations and aspects, will become apparent and be more fully understood from the following detailed description and accompanying drawings, which set forth illustrative embodiments that are indicative of the various ways in which the principles of the disclosure may be employed.

### BRIEF DESCRIPTION OF THE DRAWINGS

Non-limiting and non-exhaustive examples are described with reference to the following Figures.

FIG. 1 is a perspective view of a flight deck in an aircraft that incorporates an integrated flight test display system, in accordance with certain embodiments.

FIG. 2 is a diagrammatic view of the integrated flight test display system of FIG. 1, including a production display graphics generator, a flight test graphics generator, and a plurality of display systems, in accordance with certain embodiments.

FIG. 3 is a screenshot view of a primary flight display generated by the production display graphics generator of FIG. 2, in accordance with certain embodiments.

FIG. 4 is a close-up screenshot view of a first exemplary integrated flight test display generated by the flight test graphics generator of FIG. 2, in accordance with certain embodiments.

FIGS. 5A, 5B, and 5C are close-up screenshot views of exemplary graphical aids generated by the flight test graphics generator of FIG. 2, in accordance with certain embodiments.

FIG. 6 is a close-up screenshot view of a second exemplary integrated flight test display generated by the flight test graphics generator of FIG. 2, in accordance with certain embodiments.

FIG. 7 is a close-up screenshot view of a third exemplary integrated flight test display generated by the flight test graphics generator of FIG. 2, in accordance with certain embodiments.

### DETAILED DESCRIPTION OF EXAMPLE EMBODIMENTS

The description that follows describes, illustrates, and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a clearer description. In addition, system components can be variously arranged, as known in the art. Also, the drawings set forth herein are not necessarily drawn to scale, and in some instances, proportions may be exaggerated to more clearly depict certain features and/or related elements may be omitted to emphasize and clearly illustrate the novel features described herein. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

In various embodiments, flight display systems and methods of the present disclosure display primary flight display information and flight test information within a single graphical display. In certain embodiments, a flight display system incorporates flight test information with information that is normally provided in a primary flight display (PFD) of an aircraft to generate an integrated flight test display. In certain embodiments, the flight display system displays the integrated flight test display on a single graphical display. By incorporating this information onto a single graphical display, both the flight test information and PFD information is viewable by a pilot within a same focal plane, which can reduce pilot instrument scan time and workload, reduce pilot stress by not changing the pilot instrument scan pattern, improve test efficiency by avoiding repeated test maneuvers due to missed information, improve pilot situational awareness by reducing pilot instrument scan time dedicated to flight test information, and improve flight test data quality by enabling more efficient intake of flight test information.

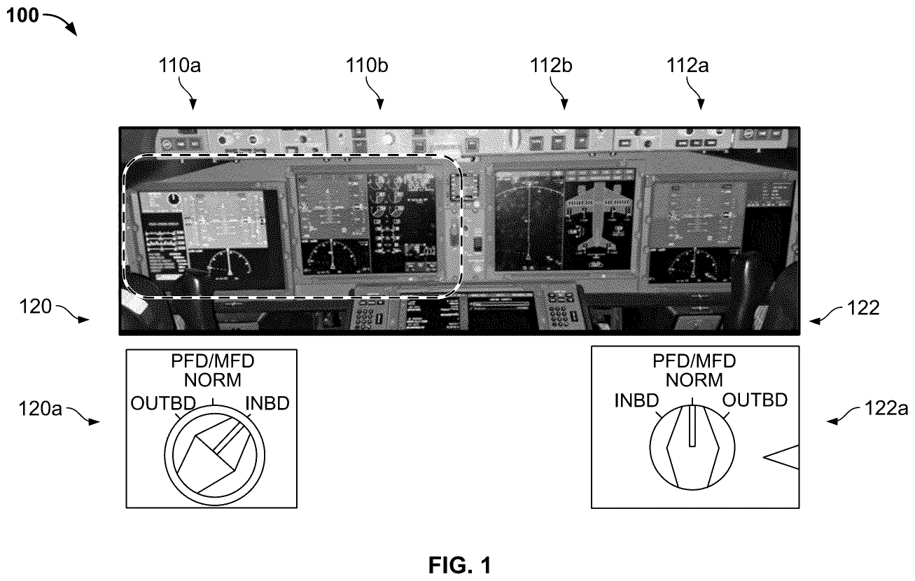

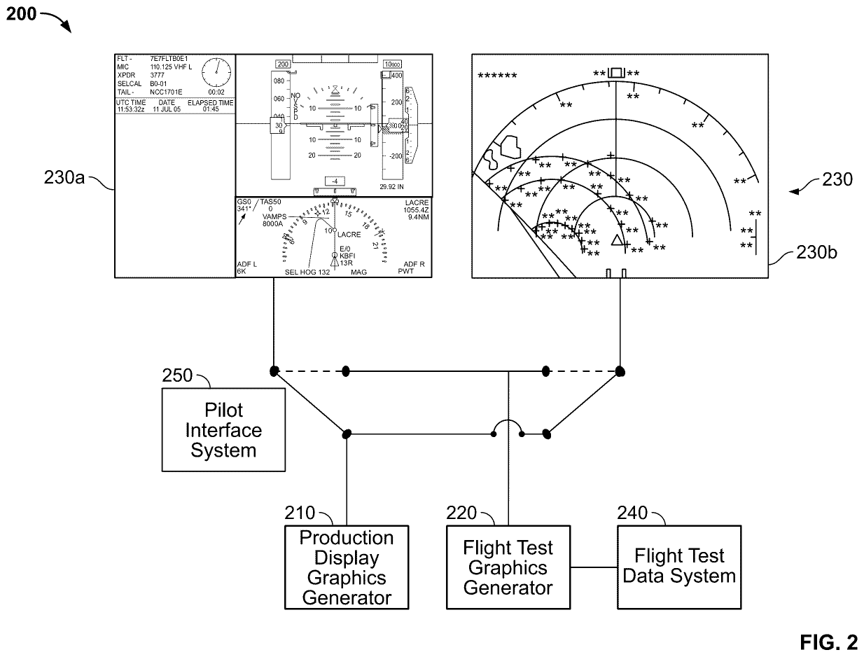

Turning to FIG. 1 and FIG. 2, an example flight deck 100 and an example flight display system 200 in accordance with one example embodiment of the present disclosure are shown. In this example embodiment, the flight deck 100 is located within a cockpit of an aircraft in which the flight display system 200 is incorporated. In various embodiments, the aircraft includes experimental aircraft, commercial aircraft, military aircraft, space vehicles, and/or their derivatives. In various embodiments, the aircraft includes fixed wing aircraft and/or rotary wing aircraft (i.e., helicopters). In some embodiments, the aircraft includes an unmanned aerial vehicle or drone and the flight deck 100 is located in a control center that is communicatively coupled with the aircraft to remotely control and/or monitor the aircraft.

The flight deck 100 includes a plurality of display devices, a plurality of pilot interface components, and/or other suitable components (e.g., auxiliary displays and/or controls, navigation displays and/or controls). In the embodiment shown in FIG. 1, the flight deck 100 includes an outboard display device 110a, an inboard display device 110b, and pilot interface components 120 for a pilot of the aircraft and includes an outboard display device 112a, an inboard display device 112b, and pilot interface components 122 for a copilot of the aircraft. The display devices 110 and 112 are configured to display information to the pilot and/or copilot for control and/or navigation of the aircraft, as described herein. In some embodiments, the display devices 110 and 112 are associated with the flight deck 100 and referred to as the pilot's forward display. The pilot interface components 120 and 122 enable the pilot and/or copilot to control the aircraft and provide inputs to the flight display system 200. In various embodiments, the pilot interface components 120 and 122 include a display switch 120a, a display switch 122a, pilot and copilot flight yokes (not labeled), and other suitable interface components. In various embodiments, the flight deck 100 includes other configurations of display devices (e.g., different quantities, display types, locations, etc.), interface components, and/or other suitable components. The display switching may be embodied as a hardware or software switch.

Referring now to FIG. 2, the flight display system 200 includes a production display graphics generator 210, a flight test graphics generator 220, and one or more display devices 230. In some embodiments, the flight display system 200 includes a flight test data system 240, a pilot interface system 250 including one or more pilot interface components, and/or other suitable devices.

In various embodiments, the production display graphics generator 210 includes one or more processors (not shown) and one or more associated memory devices (not shown), also referred to herein as a production processor and production memory device. The production memory device stores instructions that, when executed by the production processor, cause and/or configure the production processor to provide functionality as described herein. In various embodiments, all or a portion of the functionality of the production display graphics generator 210 can be implemented using application-specific integrated circuits or other suitable hardware.

In various embodiments, the production display graphics generator 210 is configured to generate one or more graphical user interfaces (“GUIs”) that include one or more of primary flight display (PFD) information, multi-function display (MFD) information, engine indicating and crew alerting system (EICAS) information, auxiliary display information, and/or other suitable information. For brevity, this information is referred to herein generally as “production flight display information” and the GUIs are referred to herein as a “production flight display.” In other words, a production flight display can include a PFD, an MFD, an EICAS GUI, an auxiliary GUI, and/or other suitable GUI. The production flight display can include various graphical aids (e.g., attitude indicator, airspeed tape), parameter values, or other suitable GUI elements.

In various embodiments, the production display graphics generator 210 includes a graphics generator within a production aircraft and/or a graphics generator within an aircraft intended to be produced (e.g., test aircraft). In various embodiments, the production display graphics generator 210 receives the PFD information from one or more sensors, processors, and/or other systems within the aircraft (not shown) and generates the GUIs based on the received PFD information.

In this illustrated example embodiment, the production display graphics generator 210 and the display device 230 are configured to communicate with each other via one or more suitable data buses (not labeled), such as a wired connection, optical connection, wireless connection, or other suitable data connection. The production display graphics generator 210 causes one or more GUIs generated by the production display graphics generator 210 to be displayed on the display device 230.

In some embodiments, the production display graphics generator 210 provides the PFD information (i.e., received from the sensors, processors, and/or other systems) to the flight test graphics generator 220. In some embodiments, the production display graphics generator 210 provides the generated GUIs to the flight test graphics generator 220 (e.g., as image data, bitmap data, or other suitable format).

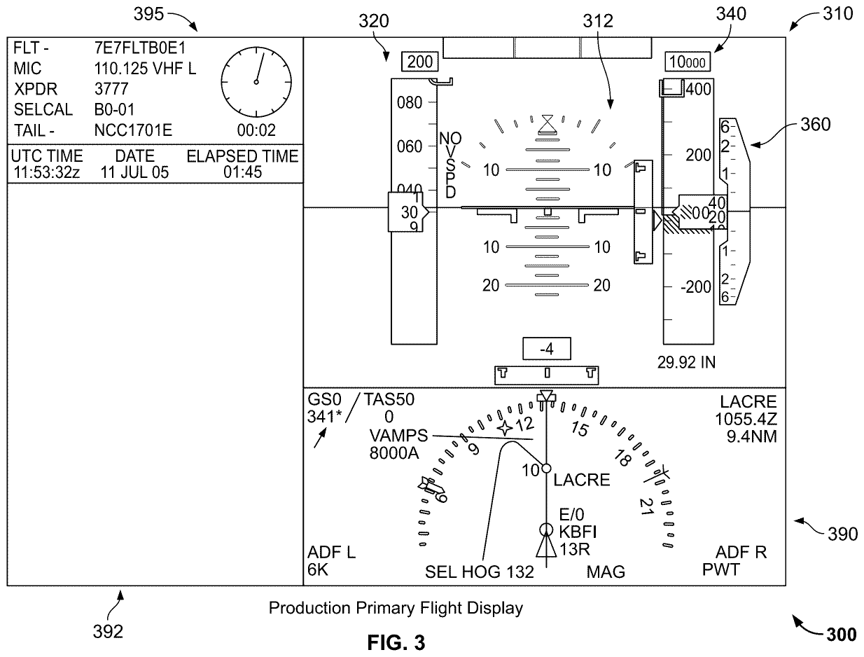

An example production GUI 300 (or “production flight display 300”) generated by the production display graphics generator 210 and having suitable production PFD information is shown in FIG. 3. In this example embodiment, the production flight display 300 includes a PFD 310, a horizontal situation indicator 390, an auxiliary panel 392, and a flight data block 395. The PFD 310 includes an attitude indicator 312, an airspeed indicator 320, an altimeter 340, a vertical speed indicator 360, and other suitable information. The flight data block 395 includes a flight number, a radio frequency, a transponder identifier, selective-calling radio identifier, tail number, time and date indicators, flight time indicator, and other suitable information.

In various embodiments, the flight test graphics generator 220 includes one or more processors (not shown) and one or more associated memory devices (not shown), also referred to herein as a flight test processor and flight test memory device. The flight test memory device stores instructions that, when executed by the flight test processor, cause and/or configure the flight test processor to provide functionality as described herein. In various embodiments, all or a portion of the functionality of the flight test graphics generator 220 can be implemented using application-specific integrated circuits or other suitable hardware.

In this illustrated example embodiment, the flight test graphics generator 220 and the display device 230 are configured to communicate with each other via one or more suitable data buses (not labeled), such as a wired connection, optical connection, wireless connection, or other suitable data connection. In some embodiments, the production display graphics generator 210 and the flight test graphics generator 220 employ separate, independent data buses to communicate with the display device 230. In certain embodiments, the flight test graphics generator 220 employs a same data bus as the production display graphics generator 210, for example, using an auxiliary data port, piggyback connection, or other suitable connection. In some embodiments, the flight test graphics generator 220 is connected to an auxiliary input associated with the display device 230, which ensures that one or more reliability and/or failure modes of the production display graphics generator 210 are retained.

In various embodiments, the flight test graphics generator 220 is configured to generate one or more GUIs, referred to collectively herein as an integrated flight test display, which include both production flight display information and flight test display information. The flight test graphics generator 220 is configured to cause the generated integrated flight test display to be displayed on the display device 230. Generally, the production flight display information includes information related to operating the aircraft, while the flight test display information includes information related to test maneuvers to be performed for testing of the aircraft, such as reaching a target airspeed, exceeding a target altitude, operating with a target angle of attack for a target duration of time, a predetermined flight test routine including a plurality of test maneuvers, sets of flight test routines, or other suitable test maneuvers. In some embodiments, the test maneuvers include changes to aircraft settings and/or configurations, such as raising and/or lowering a landing gear of the aircraft, activating and/or deactivating a component or feature, changing parameter values for components or features, or other suitable changes. As described above, by incorporating the production flight display information and the flight test display information onto a single GUI and/or combining GUIs into a single display device, the flight test graphics generator 220 enables a reduction in pilot instrument scan time and workload, a reduction in pilot stress by not requiring a change to the pilot instrument scan pattern, improved test efficiency by avoiding repeated test maneuvers due to missed information, improved pilot situational awareness by reducing pilot instrument scan time dedicated to flight test information, and/or improved flight test data quality by enabling more efficient intake of flight test information.

In various embodiments, the flight test graphics generator 220 is configured to automatically update the integrated flight test display according to the test maneuvers (e.g., as test maneuvers are initiated, performed, completed, and/or repeated). In certain embodiments, for each such test or a test component within that test, the flight test graphics generator 220 updates the integrated flight test display to display a new graphical aid and/or parameter, modify a previously displayed graphical aid and/or parameter, and/or remove a previously displayed graphical aid and/or parameter from the integrated flight test display. In certain embodiments, the flight test graphics generator 220 updates the integrated flight test display in real-time as production flight display information and/or flight test display information change.

In various embodiments, the flight test graphics generator 220 is configured to display the integrated flight test display in parallel with the production flight display (or a reduced size of the production flight display). This enables the flight crew to readily monitor both production flight display information (e.g., attitude, airspeed, altitude) and flight test display information from a single screen, while still providing a backup display that is unencumbered by the flight test display information. In some such embodiments, the flight test graphics generator 220 generates and displays both the integrated flight test display and the production flight display on the display devices 230. In some such embodiments, the flight test graphics generator 220 generates and displays the integrated flight test display on the display devices 230 and the production display graphics generator 210 generates and displays the production flight display on the display devices 230. In some such embodiments, the flight test graphics generator 220 generates and displays the integrated flight test display on the display devices 230, the production display graphics generator 210 generates and provides the production flight display to the flight test graphics generator 220, and the flight test graphics generator 220 displays the production flight test display on the display devices 230.

In various embodiments, the production flight display information of the integrated flight test display includes PFD information, MFD information, EICAS information, auxiliary display information, and/or other suitable information. In some embodiments, all or a portion of the production flight display information generally corresponds to the production flight display information associated with the production flight display generated by the production display graphics generator 210, as described above.

In contrast to the production flight display generated by the production display graphics generator 210, the flight test graphics generator 220 generates the integrated flight test display to also include the flight test display information within a same GUI. In various embodiments, the flight test graphics generator 220 generates the integrated flight test display to include: (a) production graphical aids and/or parameters associated with the production flight display information but not the flight test display information; (b) flight test graphical aids and/or parameters associated with the flight test display information but not the production flight display information; (c) integrated graphical aids and/or parameters associated with both the production flight display information and the flight test display information. In other words, the integrated flight test display can include graphical aids that also appear in the production flight display, graphical aids that are not present within the production flight display, and/or graphical aids that are a modified or hybrid version of a graphical aid that appears in the production flight display. Put another way, the integrated flight test display can include an integrated PFD having both PFD information and flight test information, an integrated MFD having both MFD information and flight test information, an integrated EICAS GUI having both EICAS information and flight test information, an integrated auxiliary GUI having both auxiliary information and flight test information, and/or other suitable integrated GUI.

In various embodiments, the flight test graphical aids and/or integrated graphical aids include parameter tapes (e.g., an airspeed tape, a load factor tape), parameter digital boxes (e.g., a graphical element highlighting a parameter), parameter value indicators (e.g., graphic indications of current value, target value, minimum target value, maximum target value, minimum achieved value, maximum achieved value, average value), parameter range indicators (e.g., target ranges and/or tolerances), and/or other suitable graphical aids or visual representations. In various embodiments, the parameters include digital values (e.g., “184” or “31000”) of various parameters, such as airspeed, altitude, angle of attack, etc.

In various embodiments, the flight test graphical aids and/or integrated graphical aids employ a visual format similar to the production flight display 300. In some such embodiments, the flight test graphical aids and/or integrated graphical aids employ additional display features (e.g., hash marks, chevrons, staples, pop-out windows, or other “widgets”) that identify and/or magnify different parameter ranges, parameter values, and/or parameter values within a portion of a parameter range. In various embodiments, the flight test graphics generator 220 employs one or more different colors for the flight test graphical aids and/or integrated graphical aids based on various parameter values, such as a magenta color to display and/or indicate a target value, a white color to display and/or indicate a current value below a target value; an amber color to display and/or indicate a current value above a target value, and a red color to display and/or indicate a current value above a limit associated with that value. In certain embodiments, the flight test graphics generator 220 selects one or more colors for a graphical aid based on the display device 230 on which that graphical aid will be displayed, for example, selecting from a set of colors supported by a particular display device 230. In certain embodiments, the flight test graphics generator 220 selects one or more colors for a graphical aid based on a plurality of display devices having different sets of available colors, for example, to ensure color consistency for that graphical aid across the plurality of display devices. In certain embodiments, the flight test graphics generator 220 selects one or more colors for a graphical aid based on regulations, laws, and/or guidelines associated with aircraft flight displays.

In various embodiments, the flight test graphics generator 220 receives the production flight display information and/or the flight test display information employed for generating the integrated flight test display from: (a) one or more sensors, processors, and/or other systems within the aircraft (not shown); (b) the production display graphics generator 210 (e.g., as information, image data, or other suitable format); (c) the flight test data system 240; (d) one or more sensors, processors, and/or other systems outside of the aircraft, such as a ground station, other aircraft, or satellite (not shown); and/or other suitable sources.

In various embodiments, the display devices 230 include the display devices 110, the display devices 112, and/or other suitable display devices. In the embodiment shown in FIG. 2, the display devices 230 include a pilot display 230a and a copilot display 230b. In various embodiments, the display devices 230 includes liquid crystal displays (LCDs), organic light emitting diode (OLED) displays, head-up display (or other suitable transparent display), augmented reality display, mixed reality display, head-mounted display, helmet-mounted display, holographic display, and/or other suitable display devices. In various embodiments, the display device 230 includes liquid crystal displays, liquid crystal on silicon (LCoS), light emitting diodes, optical waveguides, digital micro-mirrors, OLEDs, optical lenses, projectors, and/or other suitable components. In some embodiments, the display devices 230 include multiple, different display devices, such as an OLED display (e.g., on the flight deck 100), a helmet-mounted display on a helmet worn by the pilot, and a head-up display fixed near a windscreen of the aircraft. For brevity, only a single display device 230 is described in detail herein.

In various embodiments, the flight test data system 240 includes one or more processors (not shown) and one or more associated memory devices (not shown). The memory device stores instructions that, when executed by the processor, cause and/or configure the processor to provide functionality as described herein. In various embodiments, all or a portion of the functionality of the flight test data system can be implemented using application-specific integrated circuits or other suitable hardware.

In various embodiments, the flight test data system 240 is configured to store flight test data associated with the aircraft while the pilot causes the aircraft and/or associated instruments and devices to perform one or more test maneuvers. In some embodiments, the flight test data system 240 also provides flight test data information to the flight test graphics generator 220 via a suitable data bus (not labeled), such as a wired connection, optical connection, wireless connection, or other suitable data connection.

In various embodiments, the pilot interface system 250 include user input devices such as buttons, keypads, switches, touch-screen displays, flight yokes, or other suitable interface components that enable a pilot or other air crew member to provide input to the flight display system 200. In various embodiments, the pilot interface system 250 include interface components that are native to the flight deck 100 (such as the pilot interface components 120 and 122), non-native interface components (such as the display switches 120a and 122a), and/or customized native interface components (such as a switch or button that is native to the flight deck 100 and configured to provide the additional functionality described herein).

In various embodiments, the flight test graphics generator 220 enables the pilot to employ the pilot interface system 250 to modify the integrated flight test display to include flight crew parameters and/or preferences, such as a preferred display style of production flight display information and/or flight test display information, customized test parameters, and/or other suitable information.

In various embodiments, the flight test graphics generator 220 is configured to divide and/or subdivide one or more regions of a display device 230. In various embodiments, the flight test graphics generator 220 divides one or more of a first region that includes the entire display device 230, a second region that is employable for display of the PFD 310, a third region that is employable for display of a multi-function display, a fourth region that is employable for display of the horizontal situation indicator 390, a fifth region that is employable for display of the auxiliary panel 392, and/or other suitable regions into two or more slots, such as left and right slots, upper and lower slots, and/or other suitable configurations of slots. In certain embodiments, the flight test graphics generator 220 combines two or more divided slots into a combined slot and/or combines two or more regions into a combined “slot.” In certain embodiments, the flight test graphics generator 220 selects and displays one or more GUIs within one, two, or more slots, such as one GUI per slot, two GUIs per slot, one GUI over two or more slots, etc. In other words, the flight test graphics generator 220 allocates the slots to various GUIs and displays the GUIs within the allocated slots. In various embodiments, the flight test graphics generator 220 divides the regions into slots, combines the slots, allocates the slots, and/or selects the GUIs to be displayed within the allocated slots dynamically, automatically, and/or responsive to pilot input (e.g., based on production flight display information, flight test display information, test maneuvers, pilot inputs, and/or other suitable criteria). In some embodiments, the flight test graphics generator 220 automatically divides the regions into slots, combines the slots, allocates the slots, and/or selects the GUIs to be displayed within the allocated slots as test maneuvers are performed and/or completed such that the displayed GUIs provide suitable information to the pilot and/or copilot as the test maneuvers are performed (e.g., showing GUIs that are relevant to a test maneuver being currently performed and/or a next test maneuver to be performed).

In various embodiments, the flight test graphics generator 220 enables the pilot to employ the pilot interface system 250 to selectively toggle which GUI is displayed by the display devices 230, for example, by changing between the production flight display (or various configurations thereof) and the integrated flight test display (or various configurations thereof). In various embodiments, the flight test graphics generator 220 enables the pilot to employ the pilot interface system 250 to select which GUI(s) are displayed by the display device 230, a location of each selected GUI within the display devices 230, which graphical aids and/or flight test information to be displayed within each selected GUI, and/or other suitable interface parameters.

Referring to FIG. 1, in one example embodiment, the pilot employs the display switch 120a to select a location for a display of production flight display that includes a primary flight display and a multi-function display. In this example embodiment, the display switch 120a is configured to switch between: (1) displaying the production flight display on the outboard display device 110a (“OUTBD”) and displaying the integrated flight test display on the inboard display device 110b; (2) displaying the production flight display on both the outboard display device 110a and the inboard display device 110b (“NORM”) and not displaying the integrated flight test display on the display devices 110 (e.g., a default or production configuration of the display devices 110 and GUIs); and (3) displaying the production flight display on the inboard display device 110b (“INBD”) and displaying the integrated flight test display on the outboard display device 110a. In the example embodiment shown in FIG. 1, the production flight display, when displayed with the integrated flight test display, includes the primary flight display in a left slot and the EICAS GUI in a right slot. Specifically, the flight test graphics generator 220 displays the primary flight display in a left slot of the inboard display device 110b, the EICAS GUI in a right slot of the inboard display device 110b, and an integrated flight test display in the outboard display device 110a when the integrated flight test display toggle switch 120a is set to “INBD”. Similarly, the flight test graphics generator 220 displays the primary flight display in the outboard display device 112a and a multi-function display in the inboard display device 112b when the integrated flight test display toggle switch 122a is set to “NORM”. Other configurations and/or combinations of the GUIs, slots, display devices, and/or integrated flight test display toggle switches are within the scope of the present disclosure.

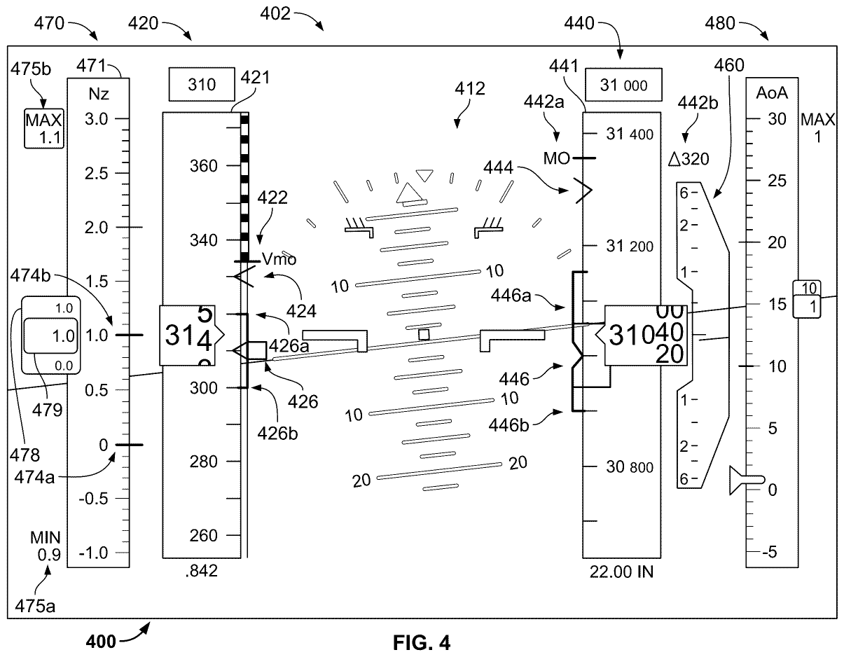

Turning to FIG. 4, a first example integrated GUI 400 (or “integrated flight test display 400”) generated by the flight test graphics generator 220 in accordance with an example embodiment is shown. In this example embodiment, the integrated flight test display 400 includes an integrated PFD 402. The integrated PFD 402 includes an attitude indicator 412, an airspeed indicator 420, an altimeter 440, a vertical speed indicator 460, a load factor indicator 470, an Angle of Attack (AoA) indicator 480, and other suitable information. Although a plurality of different graphical aids are shown in the embodiment of FIG. 4, not all such graphical aids may be present simultaneously in actual flight and/or test conditions. These graphical aids are shown and described herein in a single GUI for brevity. Other GUIs and configurations of graphical aids are contemplated and within the scope of the present disclosure.

In this example embodiment, the attitude indicator 412 and the vertical speed indicator 460 generally correspond to the attitude indicator 312 and the vertical speed indicator 360, respectively, and are not described in detail for brevity.

The airspeed indicator 420 includes an airspeed tape 421 having horizontal hash marks indicating airspeed (i.e., labeled from 260 to 360), an airspeed boundary indicator 422, a target airspeed indicator 424, and a target airspeed tolerance 426. In this embodiment, the flight test graphics generator 220 generates the airspeed tape 421 as a production graphical aid and generates the airspeed boundary indicator 422, the target airspeed indicator 424, and the target airspeed tolerance 426 as flight test graphical aids that are separate from the airspeed tape 421. In other embodiments, the flight test graphics generator 220 generates each of the airspeed tape 421, the airspeed boundary indicator 422, the target airspeed indicator 424, and the target airspeed tolerance 426 as a single, integrated graphical aid (i.e., a modified version of the airspeed indicator 320). By displaying the airspeed boundary indicator 422, the target airspeed indicator 424, and the target airspeed tolerance 426 (or other suitable flight test display information related to airspeed) on and/or near the airspeed tape 421, the flight test display information is more easily viewed by the pilot, reduces instrument scan time, etc.

The airspeed boundary indicator 422 indicates an airspeed at which the aircraft may exceed (or fall below) a boundary airspeed associated with the aircraft. In this embodiment, the airspeed boundary indicator 422 includes a text or digital indicator (i.e., instead of analog) for a maximum operating airspeed (V_{MO} or M_{MO}) of the aircraft. In other embodiments, the flight test graphics generator 220 indicates, alternatively or in addition to the V_{MO} or M_{MO}, a different suitable airspeed boundary, such as a maximum speed for stability characteristics (V_{FC}), a maximum Mach number for stability characteristics (M_{FC}), a maximum dive speed (V_{D}), a maximum dive Mach number (M_{D}), or other suitable airspeed boundary.

The target airspeed indicator 424 includes a left-facing chevron (shown at an airspeed of 330) that indicates a target airspeed for a current test maneuver. In some embodiments, the target airspeed indicator 424 further includes a tolerance range indication for the target airspeed for the current test maneuver, such as a staple having an upper leg and lower leg, as described below. In other embodiments, the target airspeed indicator 424 includes a hollow chevron, an arrow, a bracket, or other suitable shape.

The target airspeed tolerance 426 includes a target airspeed (shown at an airspeed of 310) and includes a “staple” having an upper leg 426a indicating an upper bound of a tolerance range and a lower leg 426b indicating a lower bound of the tolerance range. In this embodiment, the upper leg 426a and the lower leg 426b have a same length to indicate a tolerance range that is centered on the target airspeed. In other embodiments, the upper leg 426a and the lower leg 426b have different lengths to indicate a tolerance range having an upper bound further from the target airspeed than a lower upper bound (e.g., lower bound at 300, target at 310, upper bound at 340), or a tolerance range having an upper bound closer to the target airspeed than a lower upper bound.

In various embodiments, the flight test graphics generator 220 selects one or more colors for the airspeed boundary indicator 422, the target airspeed indicator 424, and/or the target airspeed tolerance 426 that contrast with the airspeed tape 421, such as green, amber, red, white, cyan, or magenta, to visually distinguish the flight test display information from the production flight display information and/or the airspeed tape 421. In some embodiments, the flight test graphics generator 220 selects a red color to indicate a value that is over a limit, an amber color to indicate a value that is over a target, a white color to indicate a value that is below a target, and/or other suitable colors.

The altimeter 440 includes an altitude tape 441 having horizontal hash marks indicating altitude (i.e., labeled from 30800 to 31400), an altitude boundary indicator 442, a target altitude indicator 444, and a target altitude tolerance 446. In this embodiment, the flight test graphics generator 220 generates the altitude tape 441 as a production graphical aid and generates the altitude boundary indicator 442, the target altitude indicator 444, and the target altitude tolerance 446 as flight test graphical aids that are separate from the altitude tape 441. In other embodiments, the flight test graphics generator 220 generates each of the altitude tape 441, the altitude boundary indicator 442, the target altitude indicator 444, and the target altitude tolerance 446 as a single, integrated graphical aid (i.e., a modified version of the altimeter 340). By displaying the altitude boundary indicator 442, the target altitude indicator 444, and the target altitude tolerance 446 (or other suitable flight test display information related to altitude) on and/or near the altitude tape 441, the flight test display information is more easily viewed by the pilot, reduces instrument scan time, etc.

The altitude boundary indicator 442 indicates an altitude at which the aircraft may exceed (or fall below) a boundary altitude associated with the aircraft, the flight, and/or a geographic region in which the aircraft is flying. In this embodiment, the altitude boundary indicator 442 includes a text indicator 442a (“MO” shown at an altitude of 31360) that indicates the maximum operating airspeed transition altitude from Mach to airspeed is being displayed (shown to the left of the altitude tape 441) and a proximity indicator 442b that indicates how close the aircraft is to that displayed boundary (“320” feet to MO at 31360) and a direction of deviation to reach that displayed boundary (e.g., an upward facing delta when the displayed boundary is above a current altitude of the aircraft, a downward facing delta when the displayed boundary is below a current altitude of the aircraft). In other embodiments, the proximity indicator 442b is displayed near the top of the altitude tape 441 when the displayed boundary is above the current altitude of the aircraft, and the proximity indicator 442b is displayed near the bottom of the altitude tape 441 when the displayed boundary is below the current altitude of the aircraft. In other embodiments, the flight test graphics generator 220 displays other suitable altitude boundaries, such as a dive transition altitude (D), a stability characteristics transition altitude (FC), a cruising altitude, a flight ceiling associated with the flight and/or geographic region in which the aircraft is flying, a cloud cover altitude, etc. In some embodiments, the flight test graphics generator 220 generates an altitude boundary indicator, alternatively or in addition to the altitude boundary indicator 442, near a bottom of the altitude tape 441 for a boundary altitude that is lower than a current altitude of the aircraft, such as a minimum altitude permitted by regulations, an estimated distance to terrain, or other suitable boundary.

The target altitude indicator 444 includes a right-facing chevron (shown at an altitude of 31300) that indicates a target altitude for a current test maneuver. In some embodiments, the target altitude indicator 444 further includes a tolerance range indication for the target altitude for the current test maneuver, such as a staple having an upper leg and lower leg, as described herein. In other embodiments, the target altitude indicator 444 includes a hollow chevron, an arrow, a bracket, or other suitable shape.

The target altitude tolerance 446 includes a target altitude (shown at an altitude of 31000) and includes a “staple” having an upper leg 446a indicating an upper bound of a tolerance range and a lower leg 446b indicating a lower bound of the tolerance range. In this embodiment, the upper leg 446a and the lower leg 446b have different lengths to indicate a tolerance range having an upper bound further from the target airspeed than a lower upper bound (e.g., lower bound at 30900, target at 31000, upper bound at 31150). In other embodiments, the upper leg 446a and the lower leg 446b have a same length to indicate a tolerance range that is centered on the target altitude or different lengths to indicate a tolerance range having an upper bound closer to the target altitude than a lower upper bound.

In various embodiments, the flight test graphics generator 220 selects one or more colors for the altitude boundary indicator 442, the target altitude indicator 444, and the target altitude tolerance 446 that contrast with the altitude tape 441, such as green or magenta, to visually distinguish the flight test display information from the production flight display information.

In the embodiment shown in FIG. 4, the load factor indicator 470 includes a load factor tape 471 having horizontal hash marks indicating a load factor experienced by the aircraft (i.e., labeled from −1.0 to 3.0), a minimum target load factor indicator 474a, a maximum target load factor indicator 474b, a minimum achieved load factor indicator 475a, a maximum achieved load factor indicator 475b, a target load factor range digital indicator 478, and a current load factor digital indicator 479. The load factor indicator 470 provides information helpful for performing longitudinal test maneuvers. Since some test maneuvers may require the pilot to closely monitor both airspeed and load factor, the flight test graphics generator 220 provides the load factor indicator 470 next to the airspeed indicator 420 to be more easily viewed by the pilot.

In certain embodiments, the flight test graphics generator 220 generates the load factor tape 471 with color-coded horizontal hash marks, scale lines, and/or other visual indicators that indicate a severity of the load factor, for example, using red lines to indicate exceeding load factor limits, amber lines to indicate exceeding the target load factor, and/or white lines to indicate a load factor within target load factor limits.

The minimum target load factor indicator 474a, the maximum target load factor indicator 474b, and the target load factor range digital indicator 478 indicate a minimum target value (shown at a load factor of 0.0) and a maximum target value (shown at a load factor of 1.0) of the load factor to be achieved to complete a current test maneuver. The current load factor digital indicator 479 indicates a current value (1.0) of the load factor. The minimum achieved load factor indicator 475a and the maximum achieved load factor indicator 475b indicate a latched value for a minimum and maximum, respectively, for the load factor during a current test maneuver, a current flight, or other suitable time period.

In various embodiments, the flight test graphics generator 220 selects one or more colors for the minimum target load factor indicator 474a, the maximum target load factor indicator 474b, the minimum achieved load factor indicator 475a, the maximum achieved load factor indicator 475b, the current load factor digital indicator 479, and/or the target load factor range digital indicator 478 that contrast with the load factor tape 471, such as green, amber, red, white, or magenta, to visually distinguish the flight test display information from the production flight display information and/or the load factor tape 471. In some embodiments, the flight test graphics generator 220 selects a red color to indicate a value that is over a limit (e.g., danger), an amber color to indicate a value that is over a target, a white color to indicate a value that is below a target, and/or other suitable colors. In various embodiments, the flight test graphics generator 220 employs the selected color as a font color, background fill color (e.g., within the current load factor digital indicator 479), border color (e.g., around the current load factor digital indicator 479), and/or other suitable indicator.

The AoA indicator 480 indicates flight test display information related to an angle of attack for the aircraft and is described below.

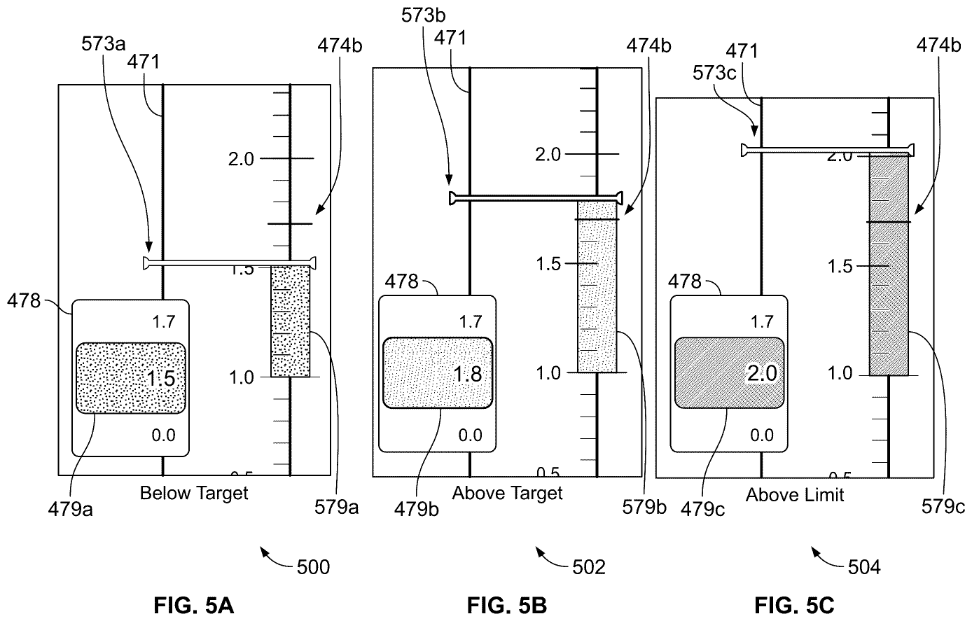

Turning to FIG. 5A, FIG. 5B, and FIG. 5C, three enlarged views of example load factor indicators 500, 502, and 504 generated by the flight test graphics generator 220 as part of a GUI (e.g., the integrated GUI 400) in accordance with an example embodiment are shown. In certain embodiments, the load factor indicators 500, 502, and 504 generally correspond to the load factor indicator 470 and include similarly labeled features, such as the load factor tape 471, the maximum target load factor indicator 474b, the target load factor range digital indicator 478, and the current load factor digital indicator 479. In this embodiment, the load factor indicators 500, 502, and 504 also includes a minimum/maximum load factor indicator 573 and a current load factor spread indicator 579.

The current load factor spread indicator 579 provides a graphical indication of the current load factor, alternatively or in addition to the current load factor digital indicator 479 (which includes a text and/or digital value).

The minimum/maximum load factor indicator 573 includes a solid line with triangle bookends and indicates a latched value for a minimum or maximum for the load factor 479 during a current test maneuver, a current flight, or other suitable time period. In FIGS. 5A and 5B, a minimum load factor indicator 573a and maximum load factor indicator 573b include a solid line with triangle bookends and indicate a latched value for a minimum and maximum, respectively, for the load factor during a current test maneuver, a current flight, or other suitable time period.

The current load factor spread indicator 579 includes an emphasized region (e.g., having a color, hash pattern, or other visual indicator) that indicates a spread between a current value of the load factor and a threshold value of the load factor (e.g., 1.0).

In various embodiments, the flight test graphics generator 220 selects one or more colors for the minimum/maximum load factor indicator 573 and/or the current load factor spread indicator 579 that contrast with the load factor tape 471, such as green, amber, red, white, or magenta, to visually distinguish the flight test display information from the production flight display information and/or the load factor tape 471. In various embodiments, the flight test graphics generator 220 employs the selected color as an indicator color (e.g., for the minimum/maximum load factor indicator 573), background fill color (e.g., within the current load factor spread indicator 579), border color (e.g., around the current load factor spread indicator 579), and/or other suitable indicator. In various embodiments, the flight test graphics generator 220 selects a red color to indicate a value that is over a limit (e.g., minimum/maximum load factor indicator 573c and current load factor spread indicator 579c shown in FIG. 5C), an amber color to indicate a value that is over a target (e.g., minimum/maximum load factor indicator 573b and current load factor spread indicator 579b shown in FIG. 5B), a white color to indicate a value that is below a target (e.g., minimum/maximum load factor indicator 573a and current load factor spread indicator 579a shown in FIG. 5A), and/or other suitable colors.

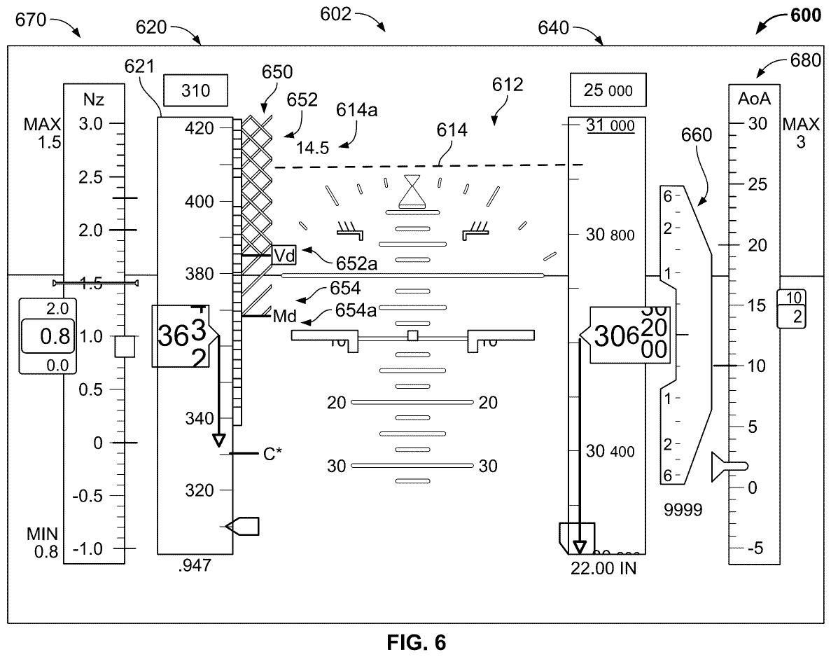

Turning to FIG. 6, a second example integrated GUI 600 (or “integrated flight test display 600”) generated by the flight test graphics generator 220 in accordance with an example embodiment is shown. In this example embodiment, the integrated flight test display 600 includes an integrated PFD 602. The integrated PFD 602 includes an attitude indicator 612, an airspeed indicator 620, an altimeter 640, a vertical speed indicator 660, a load factor indicator 670, an Angle-of-Attack (AoA) indicator 680, and other suitable information. Although a plurality of different graphical aids are shown in the embodiment of FIG. 6, not all such graphical aids may be present simultaneously in actual flight and/or test conditions. These graphical aids are shown and described herein in a single GUI for brevity. Other GUIs and configurations of graphical aids are contemplated and within the scope of the present disclosure.

In this example embodiment, the altimeter 640, the vertical speed indicator 660, the load factor indicator 670, and the AoA indicator 680 generally correspond to the altimeter 440, the vertical speed indicator 460, the load factor indicator 470, and the AoA indicator 480, respectively, and are not described in detail for brevity.

In this embodiment, the flight test graphics generator 220 generates the attitude indicator 612 as a hybrid graphical aid that includes a pitch target indicator 614. Specifically, the flight test graphics generator 220 generates the attitude indicator 612 to include the production flight display information associated with the attitude of the aircraft (e.g., corresponding to the attitude indicator 312) and flight test display information associated with the attitude of the aircraft. In this embodiment, the flight test display information includes a text and/or digital value 614a of a pitch target (“14.5”) and the pitch target indicator 614 (e.g., a dashed line) located at the pitch target within the attitude indicator 612. In other embodiments, the flight test graphics generator 220 generates the attitude indicator and pitch target indicator 614 as separate graphical aids. By displaying the pitch target indicator 614 (or other suitable flight test display information related to attitude) on and/or near the attitude indicator 612, the flight test display information is more easily viewed by the pilot, reduces instrument scan time, etc.

The airspeed indicator 620 includes an airspeed tape 621 having horizontal hash marks indicating airspeed (i.e., labeled from 320 to 420). In various embodiments, the airspeed tape 621 generally corresponds to the airspeed tape 421. In this example embodiment, the airspeed indicator 620 also includes a “stay out” indicator 650 configured to indicate ranges of airspeeds that should be avoided by the aircraft. Generally, the aircraft is limited by both airspeed and Mach to avoid structural damage to the aircraft and/or unstable flight characteristics. The airspeed limit and the Mach limit are based on altitude and other factors and may, in some scenarios, change positions with each other (i.e., with the airspeed limit being lower than the Mach limit at a first altitude but higher than the Mach limit at a second, higher altitude).

To provide a more clear graphical aid of this changing relationship between the airspeed limit and the Mach limit, the flight test graphics generator 220 generates the stay out indicator 650 to include an airspeed limit region 652 and a Mach limit region 654. In this embodiment, the airspeed limit region 652 includes angled hashes in a first direction (up and to the left) between an airspeed boundary indicator 652a and a top of the airspeed tape 621. Similarly, the Mach limit region 654 includes angled hashes in a second, opposite direction (up and to the right) between a Mach boundary indicator 654a and a top of the airspeed tape 621. As the value of V_{D} converges with the value of M_{D} in a dive, the two sets of hashes overlap to create a cross hatching as shown between the top of the airspeed tape 621 and the airspeed boundary indicator 652a. The airspeed boundary indicator 652a generally corresponds to the airspeed boundary indicator 422 and includes a maximum dive airspeed V_{D}. The Mach boundary indicator 654a generally corresponds to the airspeed boundary indicator 422 and includes a maximum dive Mach number M_{D}.

In various embodiments, the flight test graphics generator 220 generates the cross hatching (i.e., overlap between the airspeed limit region 652 and the Mach limit region 654) using hashing that is locked to each limit separately, creating movement with respect to the two different angled hashes, or the Mach limit region 654 may have cross hatching that hides the angled hashing of the airspeed limit region 652 where it overlaps with the airspeed limit region 652. In some embodiments, the flight test graphics generator 220 displays a lower portion of the hashing within the regions 652 and/or 654 as a tolerance above (or below) the actual limit shown at the airspeed boundary indicator 652a or Mach boundary indicator 654a. In such embodiments, the hashing then represents a Do Not Exceed limit that is often greater than the nominal limit value.

Although hashing and cross hashing is shown in FIG. 6 to indicate the airspeed limit region 652, the Mach limit region 654, and an overlap region of the airspeed limit region 652 and the Mach limit region 654, the flight test graphics generator 220 employs other suitable graphical elements (e.g., colors, flashing indicators, patterns) in other embodiments.

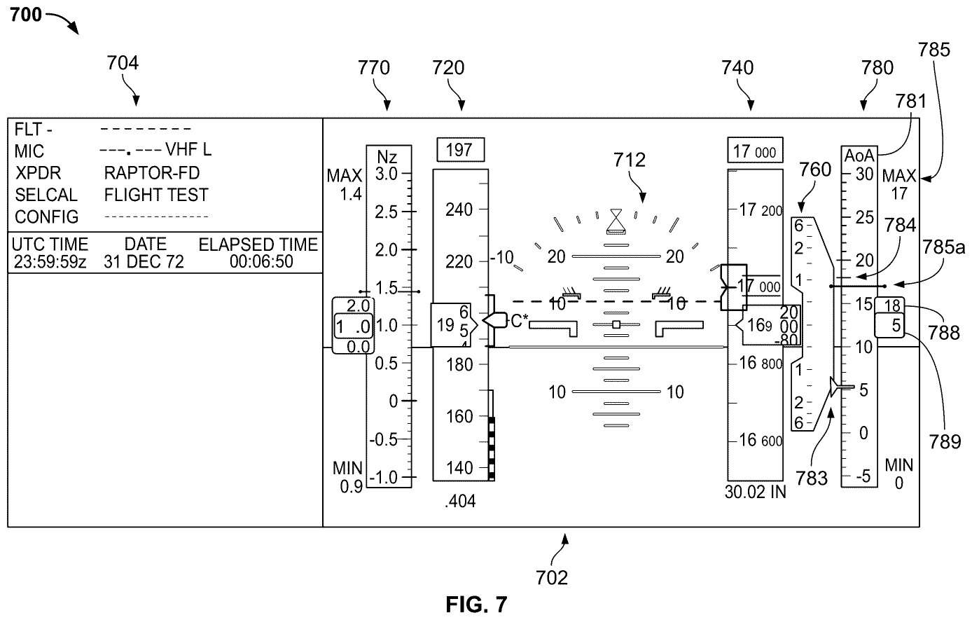

Turning to FIG. 7, a third example integrated GUI 700 (or “integrated flight test display 700”) generated by the flight test graphics generator 220 in accordance with an example embodiment is shown. In this example embodiment, the integrated flight test display 700 includes an integrated PFD 702 and an auxiliary flight display 704. The integrated PFD 702 includes an attitude indicator 712, an airspeed indicator 720, an altimeter 740, a vertical speed indicator 760, a load factor indicator 770, an Angle-of-Attack (AoA) indicator 780, and other suitable information. Although a plurality of different graphical aids are shown in the embodiment of FIG. 7, not all such graphical aids may be present simultaneously in actual flight and/or test conditions. These graphical aids are shown and described herein in a single GUI for brevity. Other GUIs and configurations of graphical aids are contemplated and within the scope of the present disclosure.

In this example embodiment, the attitude indicator 712, the airspeed indicator 720, the altimeter 740, the vertical speed indicator 760, and the load factor indicator 770 generally correspond to the attitude indicator 612, the airspeed indicator 620, the altimeter 640, the vertical speed indicator 660, and the load factor indicator 670, respectively, and are not described in detail for brevity.

The AoA indicator 780 includes an AoA tape 781 having horizontal hash marks indicating AoA (i.e., labeled from −5 to 30), a current AoA indicator 783, a target AoA indicator 784, a maximum achieved AoA digital indicator 785, a maximum achieved AoA indicator 785a, a target AoA digital indicator 788, and a current AoA digital indicator 789. In this embodiment, the flight test graphics generator 220 generates the AoA tape 781, the current AoA indicator 783, the target AoA indicator 784, the maximum achieved AoA digital indicator 785, the maximum achieved AoA indicator 785a, the target AoA digital indicator 788, and/or the current AoA digital indicator 789 as flight test graphical aids (i.e., graphical aids not included in a production flight display).

In certain embodiments, the flight test graphics generator 220 generates the AoA tape 781 with color coded horizontal hash marks, scale lines, and/or other visual indicators that indicate a severity of the AoA, for example, using red lines to indicate a high AoA, amber lines to indicate a moderate AoA, and/or white lines to indicate a low AoA.

The target AoA indicator 784 and the target AoA digital indicator 788 indicate a value (shown at an AoA value of 18) of the AoA to be achieved to complete a current test maneuver. The current AoA digital indicator 789 indicates a current value (shown at an AoA value of 5) of the AoA. The current AoA indicator 783 includes a solid line with a left triangle bookend and indicates a current value of the AoA experienced by the aircraft on the AoA tape 781. The current AoA indicator 783 provides a graphical indication of the current AoA, alternatively or in addition to the current AoA digital indicator 789 (which includes a text and/or digital value). The maximum achieved AoA digital indicator 785 and the maximum achieved AoA indicator 785a indicate a latched value (shown at an AoA value of 17) for a maximum of the AoA during a current test maneuver, a current flight, or other suitable time period.

In various embodiments, the flight test graphics generator 220 selects one or more colors for the current AoA indicator 783, the target AoA indicator 784, the maximum achieved AoA indicator 785, the target AoA digital indicator 788, and/or the current AoA digital indicator 789 that contrast with the AoA tape 781 and/or the production flight display information, such as green, amber, red, white, or magenta, to visually distinguish the flight test display information from the production flight display information and/or the AoA tape 781. In some embodiments, the flight test graphics generator 220 selects a red color to indicate a value that is over a limit (e.g., danger), an amber color to indicate a value that is over a target, a white color to indicate a value that is below a target, and/or other suitable colors. In various embodiments, the flight test graphics generator 220 employs the selected color as a font color, background fill color (e.g., within the current AoA digital indicator 789), border color (e.g., around the current AoA digital indicator 789), and/or other suitable indicator.

Implementations of the disclosure are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

As indicated above, program code instructions may be stored in memory, and executed by processing circuitry that is thereby programmed, to implement functions of the systems, subsystems, tools, and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded, and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. It will also be understood that one or more functions, and combinations of functions, may be implemented by special purpose hardware-based computer systems and/or processing circuitry s which perform the specified functions, or combinations of special purpose hardware and program code instructions.

The following paragraphs describe further aspects of the disclosure. In some implementations, the paragraphs described below can be further combined in any sub-combination without departing from the scope of the present disclosure.

In various aspects, a flight display system comprises: a display device associated with a flight deck of an aircraft; a pilot interface system associated with the flight deck of the aircraft; a production display graphics generator comprising a production processor and a production memory device that stores a first plurality of instructions; and a flight test graphics generator comprising a flight test processor and a flight test memory device that stores a second plurality of instructions. The first plurality of instructions, when executed by the production processor, cause the production processor to: receive production flight display information associated with the aircraft; generate a production flight display based on the production flight display information; and cause the production flight display to be displayed via the display device. The second plurality of instructions, when executed by the flight test processor, cause the flight test processor to: receive flight test display information associated with test maneuvers for the aircraft; generate an integrated flight test display based on the flight test display information; and cause the integrated flight test display to be displayed via the display device. The display device is selectively controllable to display one of the production flight display or the integrated flight test display.

In some aspects, the second plurality of instructions stored on the flight test memory device, when executed by the flight test processor, cause the flight test processor to automatically cause the integrated flight test display and the production flight display to be concurrently displayed via the display device based on the test maneuvers.

In some aspects, the second plurality of instructions stored on the flight test memory device, when executed by the flight test processor, cause the flight test processor to cause the integrated flight test display and the production flight display to be concurrently displayed via the display device responsive to a pilot input received via the pilot interface system.

In some aspects, the second plurality of instructions stored on the flight test memory device, when executed by the flight test processor, cause the flight test processor to: generate the integrated flight test display based on the production flight display information and the flight test display information; and cause the integrated flight test display and the production flight display to be concurrently displayed via the display device based on the test maneuvers.

In some aspects, the production flight display comprises a first graphical aid that is based on the production flight display information; and the integrated flight test display comprises the first graphical aid.

In some aspects, the production flight display comprises a first graphical aid that is based on the production flight display information; and the integrated flight test display comprises a second graphical aid that is based on the production flight display information and the flight test display information.

In some aspects, the second graphical aid is separate from the first graphical aid.

In some aspects, the integrated flight test display comprises the first graphical aid and the second graphical aid.

In some aspects, the integrated flight test display comprises: an airspeed tape indicating a range of airspeeds and a current airspeed that are associated with the aircraft; an upper airspeed limit region associated with the aircraft; and a Mach limit region associated with the aircraft. The second plurality of instructions stored on the flight test memory device, when executed by the flight test processor, cause the flight test processor to generate the upper airspeed limit region and the Mach limit region to be displayed adjacent to the airspeed tape and to partially overlap based on a current altitude of the aircraft.

In some aspects, the integrated flight test display comprises: an airspeed tape indicating a range of airspeeds and a current airspeed that are associated with the aircraft, and a target airspeed tolerance graphical aid that indicates a target airspeed for a test maneuver on the airspeed tape and a tolerance range associated with the target airspeed for the test maneuver.

In some aspects, the integrated flight test display comprises: an altitude tape indicating a range of altitudes and a current altitude that are associated with the aircraft; and a target altitude tolerance graphical aid that indicates a target altitude for a test maneuver on the altitude tape and a tolerance range associated with the target altitude for the test maneuver.

In some aspects, the integrated flight test display comprises: a load factor tape indicating a range of load factors associated with the aircraft; and a target load factor graphical aid that indicates a target load factor for a test maneuver on the load factor tape and a tolerance range associated with the target load factor for the test maneuver.

In various aspects, a flight display system comprises: a plurality of display devices associated with a flight deck of an aircraft; a pilot interface system associated with the flight deck of the aircraft; a flight test graphics generator comprising a flight test processor and a flight test memory device that stores a plurality of instructions. The plurality of instructions, when executed by the flight test processor, cause the flight test processor to: receive production flight display information associated with the aircraft; generate a production flight display based on the production flight display information; receive flight test display information associated with test maneuvers for the aircraft; generate an integrated flight test display based on the flight test display information; and selectively cause the integrated flight test display and the production flight display to be displayed via the plurality of display devices.

In some aspects, each of the plurality of display devices comprises one or more assignable slots. The plurality of instructions stored on the flight test memory device, when executed by the flight test processor, cause the flight test processor to: assign zero, one, or more first slots of the one or more assignable slots to the integrated flight test display; assign zero, one, or more second slots of the one or more assignable slots to the production flight display; cause the integrated flight test display to be displayed via the first slots and the production flight display to be displayed via the second slots.

In some aspects, the plurality of instructions stored on the flight test memory device, when executed by the flight test processor, cause the flight test processor to: combine two or more of the assignable slots into a combined slot; assign the combined slot to one of the production flight display or the integrated flight test display; and cause the one of the production flight display or the integrated flight test display assigned to the combined slot to be displayed via the combined slot.

In some aspects, the plurality of instructions stored on the flight test memory device, when executed by the flight test processor, cause the flight test processor to: automatically and dynamically, based on the test maneuvers: assign the first slots of the one or more assignable slots to the integrated flight test display; assign the second slots of the one or more assignable slots to the production flight display; and cause the integrated flight test display to be displayed via the first slots and the production flight display to be displayed via the second slots.

In various aspects, a flight display system comprises: a plurality of display devices associated with a flight deck of an aircraft; a pilot interface system associated with the flight deck of the aircraft; a production display graphics generator comprising a production processor and a production memory device that stores a first plurality of instructions; and a flight test graphics generator comprising a flight test processor and a flight test memory device that stores a second plurality of instructions. The first plurality of instructions, when executed by the production processor, cause the production processor to: receive production flight display information associated with the aircraft; and generate a production flight display based on the production flight display information. The second plurality of instructions, when executed by the flight test processor, cause the flight test processor to: receive the production flight display from the production display graphics generator; receive flight test display information associated with test maneuvers for the aircraft; generate an integrated flight test display based on the flight test display information for display via the plurality of display devices; automatically select a first display device of the plurality of display devices and display the production flight display via the first display device; and automatically select a second display device of the plurality of display devices and display the integrated flight test display via the second display device.

In some aspects, the second plurality of instructions stored on the flight test memory device, when executed by the flight test processor, cause the flight test processor to: automatically select the first display device and the second display device based on the flight test display information.

In some aspects, the second plurality of instructions stored on the flight test memory device, when executed by the flight test processor, cause the flight test processor to: automatically select the first display device and the second display device based on flight test data associated with the test maneuvers for the aircraft.

In some aspects, the second plurality of instructions stored on the flight test memory device, when executed by the flight test processor, cause the flight test processor to: generate the integrated flight test display based on the flight test display information and the production flight display information.

The implementations disclosed herein are described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed implementations are practiced in a variety of system configurations, including personal computers, laptops, smart phones, mobile tablets, hand-held devices, consumer electronics, specialty computing devices, etc. The disclosed implementations are also practiced in distributed computing environments, where tasks are performed by remote-processing devices that are linked through a communications network.

When introducing elements of aspects of the disclosure or the implementations thereof, the articles “a,” “an,” “the,” and “said” are intended to mean that there are one or more of the elements. The terms “comprising,” “including,” and “having” are intended to be inclusive and mean that there could be additional elements other than the listed elements. The term “implementation” is intended to mean “an example of.” The phrase “one or more of the following: A, B, and C” means “at least one of A and/or at least one of B and/or at least one of C.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. As an illustration, the above-described implementations (and/or aspects thereof) are usable in combination with each other. In addition, many modifications are practicable to adapt a particular situation or material to the teachings of the various implementations of the disclosure without departing from their scope. While the dimensions and types of materials described herein are intended to define the parameters of the various implementations of the disclosure, the implementations are by no means limiting and are exemplary implementations. Many other implementations will be apparent to those of ordinary skill in the art upon reviewing the above description. The scope of the various implementations of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally, and equitably entitled.

1. A flight display system comprising:
a display device associated with a flight deck of an aircraft;
a pilot interface system associated with the flight deck of the aircraft;
a production display graphics generator comprising a production processor and a production memory device that stores a first plurality of instructions, which when executed by the production processor, cause the production processor to:
receive production flight display information associated with the aircraft;
generate a production flight display based on the production flight display information; and
cause the production flight display to be displayed via the display device; and
a flight test graphics generator comprising a flight test processor and a flight test memory device that stores a second plurality of instructions, which when executed by the flight test processor, cause the flight test processor to:
receive flight test display information associated with test maneuvers for the aircraft;
generate an integrated flight test display based on the flight test display information; and
cause the integrated flight test display to be displayed via the display device;
wherein the display device is selectively controllable to display one of the production flight display or the integrated flight test display.

2. The flight display system of claim 1, wherein the second plurality of instructions stored on the flight test memory device, when executed by the flight test processor, cause the flight test processor to:
automatically cause the integrated flight test display and the production flight display to be concurrently displayed via the display device based on the test maneuvers.

3. The flight display system of claim 1, wherein the second plurality of instructions stored on the flight test memory device, when executed by the flight test processor, cause the flight test processor to:
cause the integrated flight test display and the production flight display to be concurrently displayed via the display device responsive to a pilot input received via the pilot interface system.

4. The flight display system of claim 1, wherein the second plurality of instructions stored on the flight test memory device, when executed by the flight test processor, cause the flight test processor to:
generate the integrated flight test display based on the production flight display information and the flight test display information; and
cause the integrated flight test display and the production flight display to be concurrently displayed via the display device based on the test maneuvers.

5. The flight display system of claim 4, wherein:
the production flight display comprises a first graphical aid that is based on the production flight display information; and
the integrated flight test display comprises the first graphical aid.

6. The flight display system of claim 4, wherein:
the production flight display comprises a first graphical aid that is based on the production flight display information; and
the integrated flight test display comprises a second graphical aid that is based on the production flight display information and the flight test display information.

7. The flight display system of claim 6, wherein the second graphical aid is separate from the first graphical aid.

8. The flight display system of claim 7, wherein the integrated flight test display comprises the first graphical aid and the second graphical aid.

9. The flight display system of claim 4, wherein:
the integrated flight test display comprises:
an airspeed tape indicating a range of airspeeds and a current airspeed that are associated with the aircraft;
an upper airspeed limit region associated with the aircraft; and
a Mach limit region associated with the aircraft; and
the second plurality of instructions stored on the flight test memory device, when executed by the flight test processor, cause the flight test processor to generate the upper airspeed limit region and the Mach limit region to be displayed adjacent to the airspeed tape and to partially overlap based on a current altitude of the aircraft.

10. The flight display system of claim 4, wherein:
the integrated flight test display comprises:
an airspeed tape indicating a range of airspeeds and a current airspeed that are associated with the aircraft; and
a target airspeed tolerance graphical aid that indicates a target airspeed for a test maneuver on the airspeed tape and a tolerance range associated with the target airspeed for the test maneuver.

11. The flight display system of claim 4, wherein:
the integrated flight test display comprises:
an altitude tape indicating a range of altitudes and a current altitude that are associated with the aircraft; and
a target altitude tolerance graphical aid that indicates a target altitude for a test maneuver on the altitude tape and a tolerance range associated with the target altitude for the test maneuver.

12. The flight display system of claim 1, wherein:
the integrated flight test display comprises:
a load factor tape indicating a range of load factors associated with the aircraft; and
a target load factor graphical aid that indicates a target load factor for a test maneuver on the load factor tape and a tolerance range associated with the target load factor for the test maneuver.

13. A flight display system comprising:
a plurality of display devices associated with a flight deck of an aircraft;
a pilot interface system associated with the flight deck of the aircraft; and
a flight test graphics generator comprising a flight test processor and a flight test memory device that stores a plurality of instructions, which when executed by the flight test processor, cause the flight test processor to:
receive production flight display information associated with the aircraft;
generate a production flight display based on the production flight display information;
receive flight test display information associated with test maneuvers for the aircraft;
generate an integrated flight test display based on the flight test display information; and
selectively cause the integrated flight test display and the production flight display to be displayed via the plurality of display devices.

14. The flight display system of claim 13, wherein:
each of the plurality of display devices comprises one or more assignable slots; and
the plurality of instructions stored on the flight test memory device, when executed by the flight test processor, cause the flight test processor to:
assign zero, one, or more first slots of the one or more assignable slots to the integrated flight test display;
assign zero, one, or more second slots of the one or more assignable slots to the production flight display; and
cause the integrated flight test display to be displayed via the first slots and the production flight display to be displayed via the second slots.

15. The flight display system of claim 14, wherein the plurality of instructions stored on the flight test memory device, when executed by the flight test processor, cause the flight test processor to:
combine two or more of the assignable slots into a combined slot;
assign the combined slot to one of the production flight display or the integrated flight test display; and
cause the one of the production flight display or the integrated flight test display assigned to the combined slot to be displayed via the combined slot.

16. The flight display system of claim 14, wherein the plurality of instructions stored on the flight test memory device, when executed by the flight test processor, cause the flight test processor to:
automatically and dynamically, based on the test maneuvers:
assign the first slots of the one or more assignable slots to the integrated flight test display;
assign the second slots of the one or more assignable slots to the production flight display; and
cause the integrated flight test display to be displayed via the first slots and the production flight display to be displayed via the second slots.

17. A flight display system comprising:
a plurality of display devices associated with a flight deck of an aircraft;
a pilot interface system associated with the flight deck of the aircraft;
a production display graphics generator comprising a production processor and a production memory device that stores a first plurality of instructions, which when executed by the production processor, cause the production processor to:
receive production flight display information associated with the aircraft; and
generate a production flight display based on the production flight display information; and
a flight test graphics generator comprising a flight test processor and a flight test memory device that stores a second plurality of instructions, which when executed by the flight test processor, cause the flight test processor to:
receive the production flight display from the production display graphics generator;
receive flight test display information associated with test maneuvers for the aircraft;
generate an integrated flight test display based on the flight test display information for display via the plurality of display devices;
automatically select a first display device of the plurality of display devices and display the production flight display via the first display device; and
automatically select a second display device of the plurality of display devices and display the integrated flight test display via the second display device.

18. The flight display system of claim 17, wherein the second plurality of instructions stored on the flight test memory device, when executed by the flight test processor, cause the flight test processor to:
automatically select the first display device and the second display device based on the flight test display information.

19. The flight display system of claim 17, wherein the second plurality of instructions stored on the flight test memory device, when executed by the flight test processor, cause the flight test processor to:
automatically select the first display device and the second display device based on flight test data associated with the test maneuvers for the aircraft.

20. The flight display system of claim 17, wherein the second plurality of instructions stored on the flight test memory device, when executed by the flight test processor, cause the flight test processor to:
generate the integrated flight test display based on the flight test display information and the production flight display information.
